(19) United States
(12) Patent Application Publication
(10) Pub. No.: US 2011/0113903 A1
(43) Pub. Date: May 19, 2011

(54) APPARATUS FOR CONTROLLING MOVEMENT OF A LAMP UNIT RELATIVE TO AN AUTOMOBILE BODY

(75) Inventors: Yu-Chieh Wang, Tainan Hsien (TW); Jia-Jyun Jyu, Tainan City (TW); Jian-Jhih Li, Tainan County (TW)

(73) Assignee: MAXZONE VEHICLE LIGHTING CORP., Fontana, CA (US)

(21) Appl. No.: 12/618,887

(22) Filed: Nov. 16, 2009

(51) Int. Cl. F16H 21/50

(52) U.S. Cl. 74/89.17

(57) ABSTRACT

An apparatus is adapted for controlling a lamp unit mounted on an automobile body, and includes a housing for housing input and output rods, a deceleration unit and a transmission piece. The deceleration unit includes a planet gear connected to an eccentric engaging end portion of the input rod, meshing with a ring gear fixed in the housing, and connected to the transmission piece. The output rod has a coupling end portion extending out of the housing and coupled to the lamp unit, and a rack meshing with a center gear portion of the transmission piece. When an operating end portion of the input rod rotates, the transmission piece is driven to rotate in response to movement of the planet gear with the engaging end portion of the input rod such that the output rod is movable in response to rotation of the transmission piece, thereby driving movement of the lamp unit relative to the automobile body.

### BACKGROUND OF THE INVENTION

1. Field of the Invention

The invention relates to an apparatus for controlling movement of a lamp unit, more particularly to an apparatus for controlling movement of a lamp unit relative to an automobile body.

2. Description of the Related Art

FIGS. 1 and 2 illustrate a conventional apparatus for controlling movement of a head lamp (not shown) for an automobile. The conventional apparatus includes a housing 1, an input rod 2, a transmission block 3, an output rod 4, and an angle indicating unit 5.

The input rod 2 is mounted rotatably in the housing 1, extends in a direction (A), and has an operating end portion 201 that extends out of the housing 1, and a threaded end portion 202 opposite to the operating end portion 201 in the direction (A).

The transmission block 3 is disposed movably in the housing 1, and is connected threadedly to the threaded end portion 202 of the input rod 2 such that the transmission block 3 is movable in the direction (A) relative to the input rod 2 in response to rotation of the input rod 2.

The output rod 4 is connected fixedly to the transmission block 3 so as to move with the transmission block 3. The output rod 4 has a coupling end portion 401 coupled to the head lamp. Thus, the head lamp can be driven by the output rod 4 to move in response to movement of the output rod 4, thereby varying the projection angle of rays of light emitted by the head lamp.

The angle indicating unit 5 is disposed rotatably in the housing 1, and has an annular outer surface formed with a spiral groove 501, and an indicator 502 disposed out of the housing 1 for indicating rotation of the angle indicating unit 5 that corresponds to the projection angle of rays of light emitted by the head lamp. The transmission block 3 has a driving pin 301 engaging movably the spiral groove 501 in the angle indicating unit 5 such that the angle indicating unit 5 is driven by the driving pin 301 to rotate in response to movement of the transmission block 3.

In such a configuration, since the transmission block 3 is connected threadedly to the threaded end portion 202 of the input rod 2, and has a relatively large load as a result of driving the angle indicating unit 5, movement of the transmission block 3 is relatively strenuous. Moreover, the spiral groove 501 in the angle indicating unit 5 must be accurately fabricated, thereby resulting in higher costs.

### SUMMARY OF THE INVENTION

Therefore, an object of the present invention is to provide an apparatus for controlling movement of a lamp unit relative to an automobile body that can be easily assembled and that can be manufactured at a relatively low cost.

According to the present invention, there is provided an apparatus for controlling movement of a lamp unit that is mounted movably on an automobile body. The apparatus comprises:

a housing;

an input rod mounted rotatably in the housing and having an operating end portion that extends out of the housing, and an eccentric engaging end portion opposite to the operating end portion;

a deceleration unit disposed in the housing, and including a planet gear connected to the engaging end portion of the input rod such that the planet gear co-rotates with the engaging end portion in response to rotation of the input rod, and a ring gear fixed in the housing and meshing with the planet gear;

a transmission piece disposed rotatably in the housing, and connected to the planet gear of the deceleration unit such that the transmission piece is driven by the planet gear of the deceleration unit to rotate in response to movement of the planet gear of the deceleration unit, the transmission piece having a center gear portion; and
an output rod mounted movably in the housing, and having a coupling end portion that extends out of the housing and that is adapted to be coupled to the lamp unit, and a rack meshing with the center gear portion of the transmission piece such that the output rod is movable relative to the housing in response to rotation of the center gear portion of the transmission piece, thereby driving movement of the lamp unit relative to the automobile body.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional apparatus for controlling movement of a head lamp for an automobile;

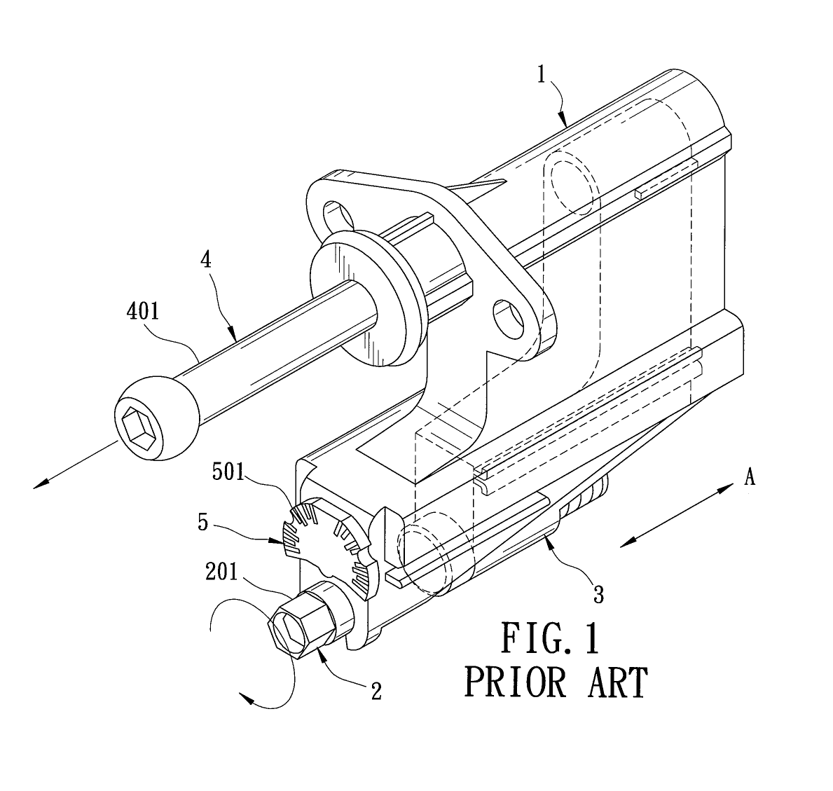

FIG. 2 is a fragmentary, partly schematic sectional view of the conventional apparatus;

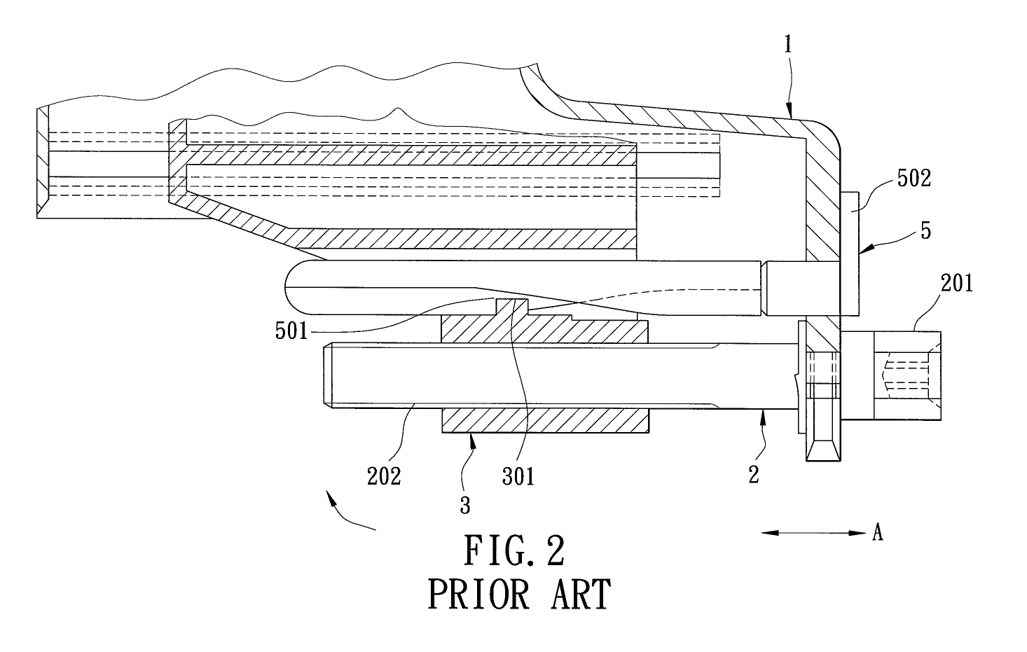

FIG. 3 is a schematic side view showing the preferred embodiment of an apparatus for controlling movement of a lamp unit on an automobile body according to the present invention;

FIG. 4 is an exploded perspective view showing the preferred embodiment;

FIG. 5 is a schematic sectional view showing the preferred embodiment;

FIG. 6 is an assembled perspective view showing the preferred embodiment; and

FIG. 7 is a partly schematic sectional view of the preferred embodiment taken along line VII-VII in FIG. 5.

### DETAILED DESCRIPTION OF THE PREFERRED EMBODIMENT

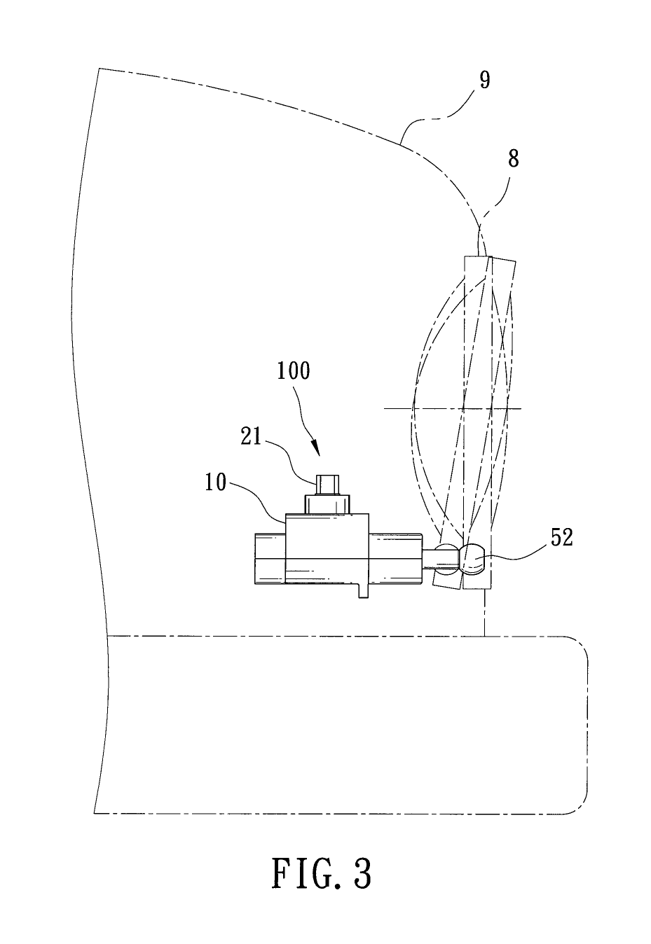

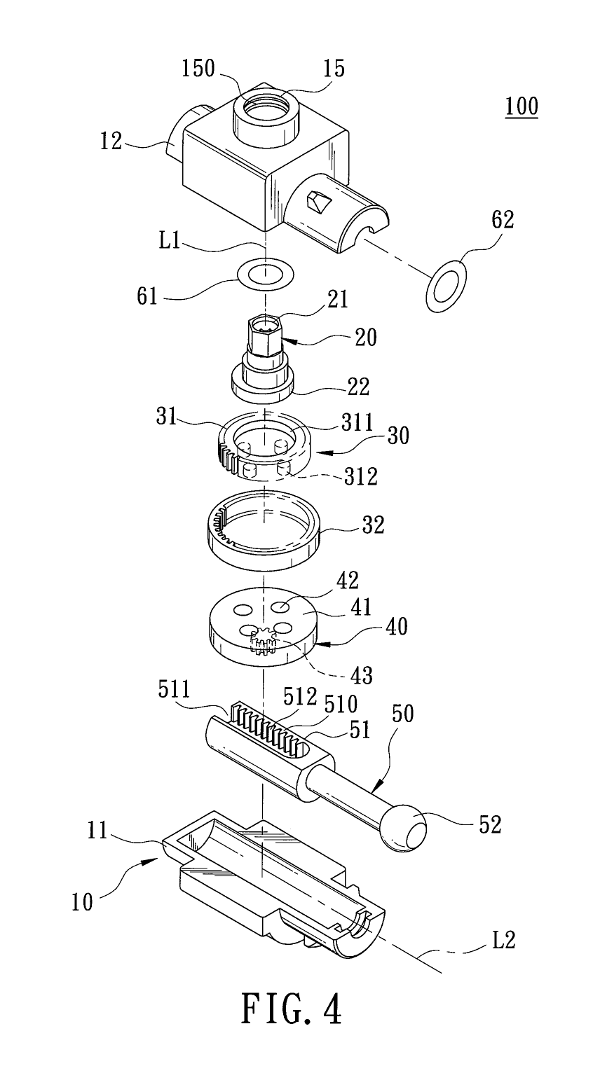

Referring to FIGS. 3 to 6, the preferred embodiment of an apparatus 100 for controlling a lamp unit 8, such as a head lamp, that is mounted movably on an automobile body 9 according to the present invention is shown to include a housing 10, an input rod 20, a deceleration unit 30, a transmission piece 40, an output rod 50, and first and second sealing rings 61, 62.

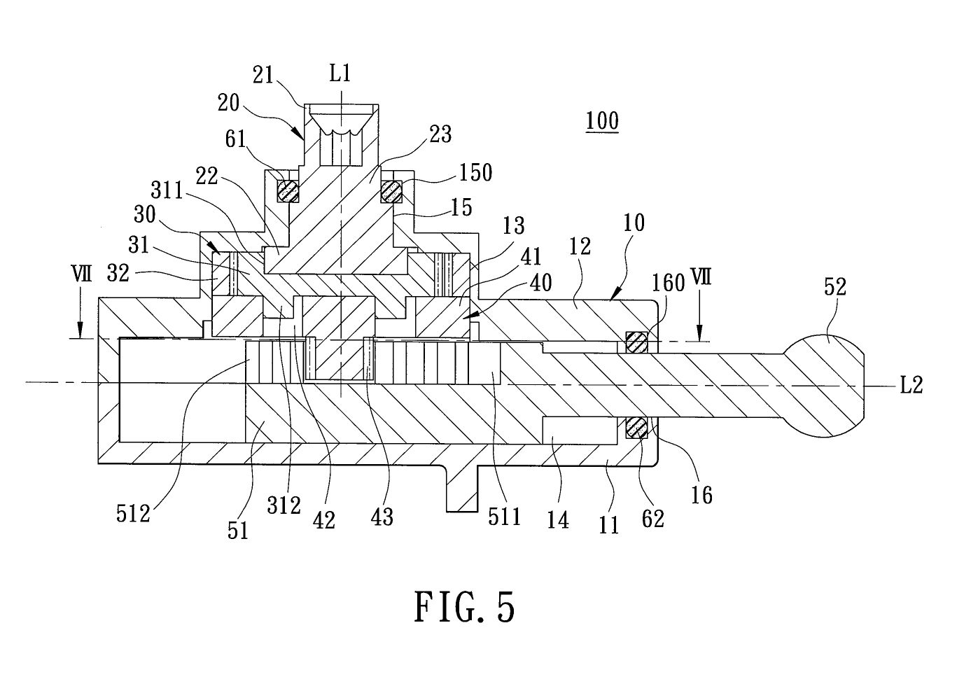

In this embodiment, as shown in FIG. 5, the housing 10 is composed of complementary lower and upper casing parts 11, 12 connected to each other and defining an inner receiving space 13, an axial hole 14 and a second opening 16 therebetween. The upper casing part 12 is formed with a first opening 15 in spatial communication with the inner receiving space 13 and extending along a first axis (L1). The axial hole 14 is in spatial communication with the inner receiving space 13 and the second opening 16, and extends along a second axis (L2) transverse to the first axis (L1). Each of the first and second openings 15, 16 is defined by an annular inner wall that is formed with an annular receiving groove 150, 160.

The input rod 20 is mounted in the housing 10, and is rotatable relative to the housing 10 about the first axis (L1). The input rod 20 has an operating end portion 21 that extends out of the housing 10 through the first opening 15, an eccentric engaging end portion 22 opposite to the operating end portion 21 and disposed in the inner receiving space 13, and an intermediate portion 23 interconnecting the operating end portion 21 and the engaging end portion 22, and disposed in the first opening 15. In use, when the operating end portion 21 is operated to rotate using a tool (not shown), such as a wrench, the input rod 20 rotates, thereby resulting in eccentric rotation of the engaging end portion 22.

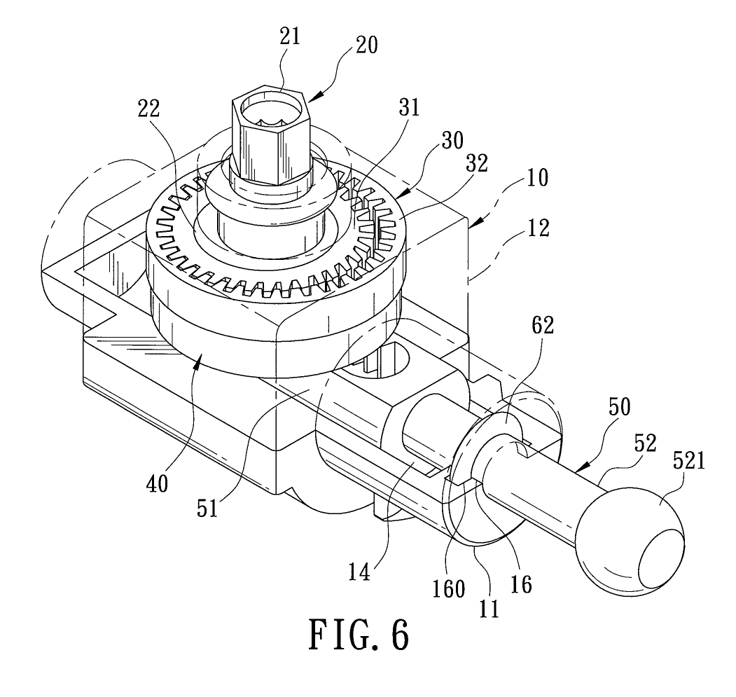

The deceleration unit 30 is disposed in the inner receiving space 13 in the housing 10, and includes a planet gear 31 and a ring gear 32. The planet gear 31 is connected to the engaging end portion 22 of the input rod 20 such that the planet gear 31 co-rotates with the engaging end portion 22 of the input rod 20 in response to rotation of the input rod 20. In this embodiment, the planet gear 31 has a top surface formed with a circular engaging recess 311 engaging fittingly the engaging end portion 22 of the input rod 20, and a bottom surface formed with a plurality of connecting posts 312. The ring gear 32 is fixed in the housing 10 and meshes with the planet gear 31, as shown in FIGS. 5 and 6.

The transmission piece 40 is disposed rotatably in the inner receiving space 13 in the housing 10, and is connected to the planet gear 31 of the deceleration unit 30. In this embodiment, the transmission piece 40 has a disk body 41 formed with a plurality of holes 42 each permitting extension of a corresponding one of the connecting posts 312 of the planet gear 31 thereinto, and a center gear portion 43. It is noted that each connecting post 312 has a diameter smaller than that of the holes 42 such that each connecting post 312 is movable in the corresponding hole 42 in the disk body 41. Thus, the transmission piece 40 is driven by the planet gear 31 of the deceleration unit 30 to rotate in response to movement of the planet gear 31 of the deceleration unit 30. In this case, movement of the planet gear 31 is eccentric rotation. As a result, rotation of the transmission piece 40 is decelerated through the deceleration unit 30.

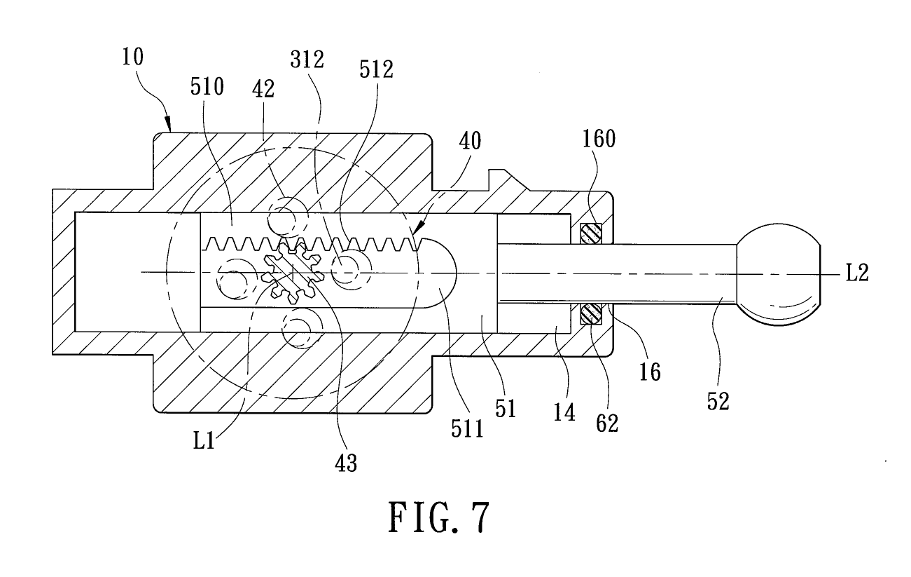

The output rod 50 is mounted movably in the axial hole 14, and has a coupling end portion 52 that extends out of the housing 10 through the second opening 16 and that is adapted to be coupled to the lamp unit 8 (see FIG. 3), and an inner end portion 51 opposite to the coupling end portion 52 and formed with a groove 511 that extends along the second axis (L2) and that is defined by a groove-defining wall 510. The groove-defining wall 510 is formed with a rack 512. As shown in FIG. 7, the center gear portion 43 of the transmission piece 40 is disposed in the groove 511 and meshes with the rack 512 such that the output rod 50 is movable relative to the housing 10 along the second axis (L2) in response to rotation of the center gear portion 43 of the transmission piece 40, thereby driving movement of the lamp unit 8 relative to the automobile body 9.

The first sealing ring 61 is sleeved on the input rod 20, and is disposed sealingly in the annular receiving groove 150, thereby sealing the first opening 15. The second sealing ring 62 is sleeved on the output rod 50, and is disposed sealingly in the annular receiving groove 160, thereby sealing the second opening 16.

In sum, the apparatus 100 of the present invention utilizes rotation of the input rod 20 that is decelerated by the deceleration unit 30 and is transmitted to the output rod 50 through the transmission piece 40 so as to drive linear movement of the output rod 50. Therefore, since the apparatus 100 of the present invention has a relatively simple structure, the apparatus 100 can be fabricated at relatively low costs, and can be easily assembled and operated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An apparatus for controlling movement of a lamp unit that is mounted movably on an automobile body, said apparatus comprising:
a housing;
an input rod mounted rotatably in said housing and having an operating end portion that extends out of said housing, and an eccentric engaging end portion opposite to said operating end portion;
a deceleration unit disposed in said housing, and including a planet gear connected to said engaging end portion of said input rod such that said planet gear co-rotates with said engaging end portion in response to rotation of said input rod, and a ring gear fixed in said housing and meshing with said planet gear;
a transmission piece disposed rotatably in said housing, and connected to said planet gear of said deceleration unit such that said transmission piece is driven by said planet gear of said deceleration unit to rotate in response to movement of said planet gear of said deceleration unit, said transmission piece having a center gear portion; and
an output rod mounted movably in said housing, and having a coupling end portion that extends out of said housing and that is adapted to be coupled to the lamp unit, and a rack meshing with said center gear portion of said transmission piece such that said output rod is movable relative to said housing in response to rotation of said center gear portion of said transmission piece, thereby driving movement of the lamp unit relative to the automobile body.

2. The apparatus as claimed in claim 1, wherein:
said transmission piece is formed with a plurality of holes; and
said planet gear of said deceleration unit has a plurality of connecting posts each extending into a corresponding one of said holes in said transmission piece and having a diameter smaller than that of said holes in said transmission piece such that each of said connecting posts is movable in the corresponding one of said holes in said transmission piece.

3. The apparatus as claimed in claim 1, wherein said input rod and said transmission piece are rotatable relative to said housing about a first axis, said output rod being movable relative to said housing along a second axis transverse to the first axis.

4. The apparatus as claimed in claim 3, wherein said output rod further has an inner end portion opposite to said coupling end portion and formed with a groove that extends along the second axis and that is defined by a groove-defining wall, said groove-defining wall being formed with said rack.

5. The apparatus as claimed in claim 1, wherein said housing is formed with a first opening for permitting extension of said input rod and said indicating end portion of said sleeve body of said angle indicating unit therethrough, and a second opening for permitting extension of said coupling end portion of said output rod therethrough, said apparatus further comprising:
a first sealing ring sleeved on said input rod and disposed sealingly in said first opening in said housing; and
a second sealing ring sleeved on said output rod and disposed sealingly in said second opening in said housing.
